(19) United States
(12) Patent Application Publication
(10) Pub. No.: US 2013/0305604 A1
(43) Pub. Date: Nov. 21, 2013

(54) METHOD FOR PRODUCING AN ORNAMENTAL HORTICULTURAL POT

(71) Applicant: Nicolas Kaya, Carpentras (FR)

(72) Inventor: Nicolas Kaya, Carpentras (FR)

(21) Appl. No.: 13/981,422

(22) PCT Filed: Nov. 25, 2011
(86) PCT No.: PCT/FR2011/052768

§ 371 Date: Jul. 24, 2013

(30) Foreign Application Priority Data
Jan. 24, 2011 (FR) 1150537

(51) Int. Cl. A01G 9/02; B29C 39/10

(52) U.S. Cl. CPC A01G 9/021; B29C 39/10
USPC 47/65.7; 264/263; 47/65.5

(57) ABSTRACT

An ornamental horticultural pot and a method for producing an ornamental horticultural pot comprising the steps of positioning and stacking stones (P) in the form of a wall against the internal walls of a mould (M) which has a predefined shape corresponding to the desired external shape of the horticultural pot; distributing a pasty binding component (B) over the bottom of the mould (M) and against the internal wall formed by the stack of stones (P); perforating the pasty binding component (B) in order to position at least one part that unblocks a hole (O) provided in the bottom of the mould (M) for draining water, said part having a height greater than the planned thickness of the bottom of the pot; allowing the pasty binding component (B) to dry for a length of time so that it solidifies; and removing the resulting horticultural pot from the mould (M).

### BACKGROUND OF THE INVENTION

The present invention relates to the general field of methods for producing horticultural pots.

Horticultural pots are generally made from materials able to be liquefied so that they can be moulded using a mould and injection method. Various other manners for manufacturing horticultural pots are known, using pottery, earthenware, etc. Ornamental horticultural pots also exist made from wood or from metal that is bent and welded to form a pot.

The invention focuses on the production of ornamental horticultural pots that are fully original.

### SUBJECT AND SUMMARY OF THE INVENTION

The objective of the present invention is therefore to allow the production of ornamental horticultural pots that are original and fully identifiable through their constituent features which impart a pleasing appearance thereto of great interest.

The invention therefore proposes a method for producing an ornamental horticultural pot comprising the steps of:
positioning and stacking stones in the form of a wall against the internal walls of a mould of predefined shape corresponding to the desired external shape of the horticultural pot;
distributing a pasty binding component over the bottom of the mould and against the internal wall formed by the stack of stones, over a thickness which observes the thickness-to-height ratio of the pot of between 1/10 and ⅕;
before or immediately after the preceding step, perforating the pasty binding component to position at least one part that unblocks a hole provided at the bottom of the mould for draining water, said part having a height greater than the planned thickness of the bottom of the pot;
allowing the pasty binding component to dry so that it solidifies;
removing the resulting horticultural pot from the mould.

With said method it is possible to obtain a pot having the appearance of a stone wall on its outer side. This is of particularly pleasing effect. It is possible at the present time to delimit a culture area with a stone wall, which is generally appreciated. Said construction is currently not possible without masonry work however. The invention allows a pot to be obtained that is marketable as such and which precisely imparts this pleasing appearance without any masonry work having to be carried out by the purchaser of the ornamental horticultural pot obtained with a method of the invention. Any mould shape allowing a wall to be built bearing against the wail of the mould can be used to implement the invention. In particular round, hence circular moulds, or square, oval, rectangular moulds whether or not flared, bowl-shaped, etc. can be used. This makes it possible to produce pots of fully diverse and varied shapes whilst maintaining the pleasing aspect of the wall obtained according to the invention on the outer side of the pot.

The invention therefore technically allows the obtaining of a pot having the structure and appearance of a wall, which is fully original,

It is noted that, for reasons of practical implementation of the method, silicone gel or similar can be used at the time of stacking the stones, This fulfils a twofold role since the stones are stacked without any binder, this will ensure minimum holding in position between the successive levels of stones. In addition, this provides sealing between the stones after applying the concrete without having to perform this jointing after releasing the pot from its mould. Nevertheless, with or without the use of a silicone gel, it may be useful to achieve a seal with swimming-pool adhesive. It is noted here however that this step is not essential.

In one embodiment, different to the preceding embodiment but also following the principles of the invention, the thickness-to-height ratio of the pot is between 1/30 and 1/10.

Said particularly low ratio was seen to be accessible by the inventor subsequent to the manufacturing of pots of large height. It was also observed that pre-dressing of the stones used allowed the thickness of the mortar to be considerably reduced. With this characteristic it is possible to obtain pots of low weight which is most advantageous for transport and handling.

Therefore, with this embodiment the pasty binding component is always distributed against the inner side of the stones stacked in the mould. This distribution of the pasty binding element against the previously stacked stones is the originality of the invention. On the inside of the pot finally obtained, the stones are no longer visible and are separated from the earth placed in the pot by the pasty component.

This therefore allows a most particular fabrication of a pot according to the invention free of any handling step of a binding component during the first step to stack the stones. The pasty component is only involved in a single subsequent step and contributes towards the sealing of the pot and the isolating of earth from the constituent stones of the pot. It is noted here that one or two inner and/or outer waterproofing layers are used, This allows the ensured sealing of the pot. The advantage of the invention is that the pot on the inside has a uniform surface of pasty component This makes it possible for any treatment of the concrete to be easily carried out without having to the treat the stones themselves.

The application of the binder on the inside of the mould and on only one side of the stones allows a most pleasing appearance to be obtained whereby there are no beads of binder between the stones visible from the outside. The distribution of the binder over the inner walls effectively allows partial penetration of the binder between the stones over a depth allowing the stones to be held in position against each other. By default the binder does not penetrate sufficiently deep to reach the mould and is therefore not visible from the outside.

Therefore by applying the principles of the invention, pots can be produced with stones having a thickness of 1 to 10 centimetres with a binder distributed over a thickness ranging from 1 to 11 centimetres. It is noted here that if stones of narrow thickness are used, it may occur that the binder is visible from the outside. Pots of a height of up to 1.8 metres can be obtained with a binder thickness of 6 centimetres which is sufficient to ensure the mechanical strength of the pot over such height.

According to one particular characteristic of the invention, the pasty binding component is chosen from among mortars, adhesive mortars, concretes, cements, coatings, fibrous adhesives.

These materials, after drying, allow very good resistance of the pot to be obtained since they are fully adapted to ensure joining of the stones in a stack such as performed according to the invention.

Advantageously, the method comprises an intermediate step to arrange one or more metal structures against the inner wall thus formed and/or at the bottom of the mould before applying the binding component.

This characteristic allows the strength of the pasty binding component to be increased,

In some cases, the presence of metal within a mortar or concrete prevents the onset of cracking,

The metal structure is chosen from among wire mesh, crossed iron bars, intermeshed metal cables.

Advantageously the pasty binding component s distributed over a thickness of between ⅛ and 1/7.

With said thickness, it is ensured that the height-to-thickness ratio of the pot imparts sufficient mechanical strength to the entire pot Nonetheless sufficient space is left in the pot to allow for culture.

According to one particular characteristic a section of pipe left permanently in the pot is used as part to unblock a hole.

The use of said part to dear a hole is advantageous since once the pasty binding component is applied, no other operation needs to be carried out to obtain a pot with a bottom hole far water drainage.

According to another particular characteristic a solid or hollow cylindrical part, that is later removed to clear the bottom hole of the pot, is used as part to unblock a hole.

This characteristic entails the need for an additional operation subsequent to application of the pasty binding component, this operation consisting of pressing down and later removing the cylindrical part from the bottom hole allowing water drainage. However this allows re-use of the cylindrical part,

Advantageously the method comprises a jointing step with waterproof joints after release from the mould to ensure the water tightness of the pot. The joints can be coloured which allows various types of finishes.

This step allows the ensured good sealing of the mould on its side walls. This step may also allow the imparting of a more pleasing appearance to the ornamental horticultural pot obtained with a method of the invention,

According to one advantageous characteristic of the invention, the method comprises a step to position at least one structure forming hoops or allowing diametrically opposite hoops to be installed after the stone positioning step and before the step to distribute the pasty binding component.

Insofar as the pasty binding component may be a heavy material, as well as the stones, it is useful for the pot to comprise means so that it can easily be lifted and moved. For this purpose, suitable devices can be used in combination with the hoops formed. With this characteristic it is also possible that a simple bar may be placed in the two hoops to allow lifting of the pot by two persons either side of the pot. Metal cables projecting from the pot as hoops can be cast in the pasty binding component, or inserts with a screw thread can be planted in the pasty binding component before it dries and sets. Hoops carrying mating screw threads can then be screwed into and unscrewed from these inserts.

Advantageously, the step to position a structure forming hoops or allowing the installation of hoops is such that this structure is placed between the metal structure and the wall obtained by stacking stones against the inner wall of the mould.

This makes it possible for the hoop-forming structure to be trapped between the stone wall built against the mould wall and the wire reinforcement. This ensures that at the time of distributing the pasty binding component the hoop-forming structure is truly trapped within the pasty binding component.

According to one advantageous embodiment the structure forming at least two hoops is a metal cable.

Good hoop strength is thereby ensured as well as optional flexibility of the hoops. In addition, the use of metal is particularly adapted within the context of the use of the pasty binding component. The metal cable is typically a braided metal cable.

According to one particular characteristic the method, at least before the distribution step of the pasty binding component, comprises a step to arrange at least one electric cable from bottom upwards in the mould and which leads to outside the top and bottom of the pot after distributing the binding component.

According to one particular characteristic the method, at least before the distribution step of the pasty binding component, comprises a step to arrange at least one pipe from bottom upwards in the mould and leading to outside the top and bottom of the pot after the distribution of the binding component.

These two latter steps can be performed simultaneously with the stone stacking step. The insertion of the cable or pipe at all events is performed before applying the pasty binding component. The cable or pipe is then trapped in the binder after it has been applied. It comprises a lower connector device for connection to an electricity or water supply network and an upper connector device for connection to a lamp or sprinkler nozzle.

The invention also concerns an ornamental horticultural pot obtained using the method of the invention.

The stones used for manufacture and in the ornamental horticultural pot obtained can be chosen from among marble blocks or slabs, earthenware blocks or slabs, pebbles, natural stones, synthetic stones, breeze blocks, faience, tiles.

The advantage of the invention can be seen here which allows a broad diversity of outer appearances to be obtained for the ornamental horticultural pots obtained with the invention, whilst maintaining the same production method of the invention and the same general structure for the ornamental horticultural pot obtained.

In one particular embodiment of the invention adapted for pots of large size, the pot is formed of at least two parts: a first so-called lower part obtained using a method of the invention and comprising a bottom, and at least a second annular part having no bottom obtained following a method of the invention and using an unblocking part to clear the bottom of this second part.

Said embodiment allows the parts of the pot to be easily transported and handled before forming the final pot at its point of installation. The thickness-to-height ratios are then heeded for each of the parts of the pot independently.

### BRIEF DESCRIPTION OF THE DRAWINGS

Other characteristics and advantages of the present invention will become apparent from the description given below with reference to the appended drawings which illustrate an example of embodiment that is in no way limiting. In the figures:

FIG. 1 illustrates a mould which can be used for implementing the invention;

FIG. 2 shows an intermediate instant during the step to position and stack stones according to the invention;

FIG. 3 shows the end of the stone positioning and stacking step of the invention;

FIG. 4 shows the positioning step of wire mesh according to the invention;

FIG. 5 shows the step to insert a hoop-forming structure between the wire mesh and the wall obtained by stacking stones against the inner wall of the mould;

FIG. 6 shows the step for depositing iron bars by crossing them over each other on the bottom of the mould;

FIG. 7 shows the result obtained before distributing the pasty binding component;

FIG. 8 shows the inside of the pot obtained after distributing the pasty binding component;

FIG. 9 is a schematic illustration of the ornamental horticultural pot such as obtained with the method of the invention;

FIG. 10 is a photo of a pot such as obtained with a method of the invention;

FIG. 11 illustrates an advantageous embodiment of the invention with an option of electric lighting;

FIG. 12 illustrates another advantageous embodiment of the invention with an automatic sprinkling option.

### DETAILED DESCRIPTION OF ONE EMBODIMENT

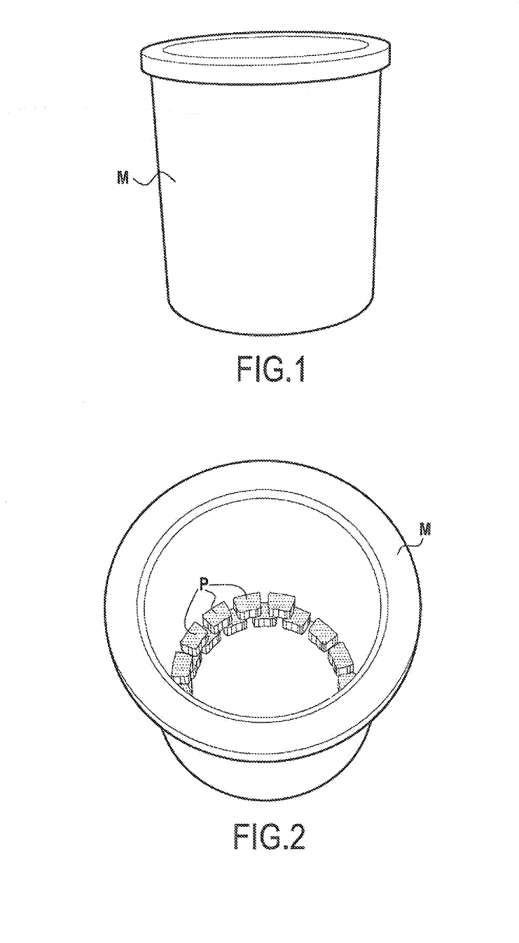

FIG. 1 shows a mould M of an ornamental horticultural pot used in a method of the invention. Typically it may be a pot formed by moulding e.g. from a plastic material. This type of material is particularly advantageous since it does not adhere to the pasty binding components which can be used. In the event of doubt in this respect, oil can be spread over the inside of the mould to prevent any adherence.

The bottom of the mould is solid but it is also possible to envisage an open-bottom mould. In this case the mould with open bottom is placed on a support acting as bottom of the mould M.

In FIG. 2, an intermediate time of the stone P positioning and stacking step against the inner wall of the mould M is illustrated. The invention uses stones P which may be slabs of natural stone or synthetic stone, or blocks of marble, earthenware, etc. It is also noted that other types of moulds M allowing a wall to be built against the inner wall of the mould M can be envisaged to implement the method for producing an ornamental horticultural pot according to the invention. Stylish moulds which have a cross-section with one or more curves e.g. sphere-shaped can therefore be used to implement the invention provided the stacking of stones P in a wall against the wall of the mould is possible.

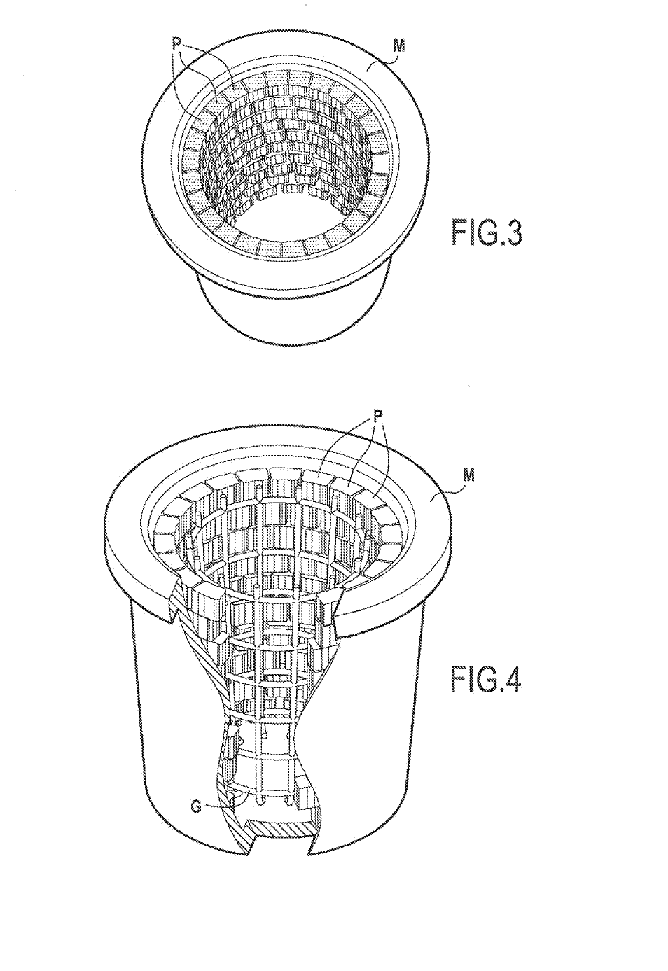

FIG. 3 shows the end of the step to position and stack stones P against the inner wall of the mould M. After this step, the pasty binding component can be directly applied over the inner side of the wall built inside the mould M.

FIG. 4 shows the result of the optional step to position a metal structure, here wire mesh G, against the inner wall formed against the inner wails of the mould M. The presence of said metal structure in a pasty binding component of concrete type allows the prevention of cracking.

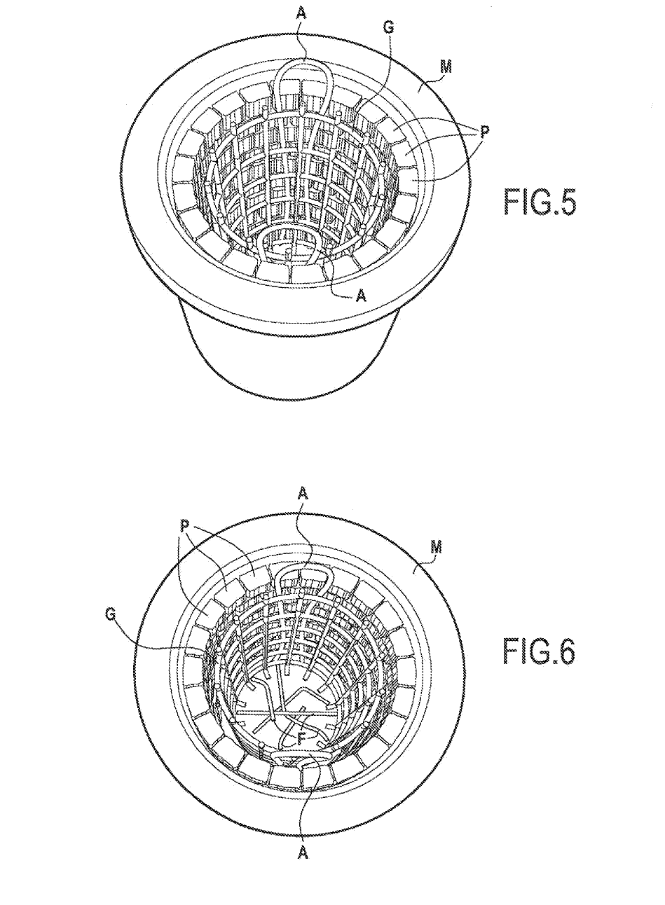

FIG. 5 illustrates the inserting that is also optional, between the wire mesh G and the wall of stones P, of a hoop-forming cable C. Here the cable C forms a first hoop A on one side of the pot. An identical structure in metal cable is installed on the diametrically opposite side so as to form a second hoop A at the top of the pot.

FIG. 6 shows the step to deposit metal structures F on the bottom of the mould. The presence of such metal structures crossing over each other and intermeshing increases the solidity of the final pot.

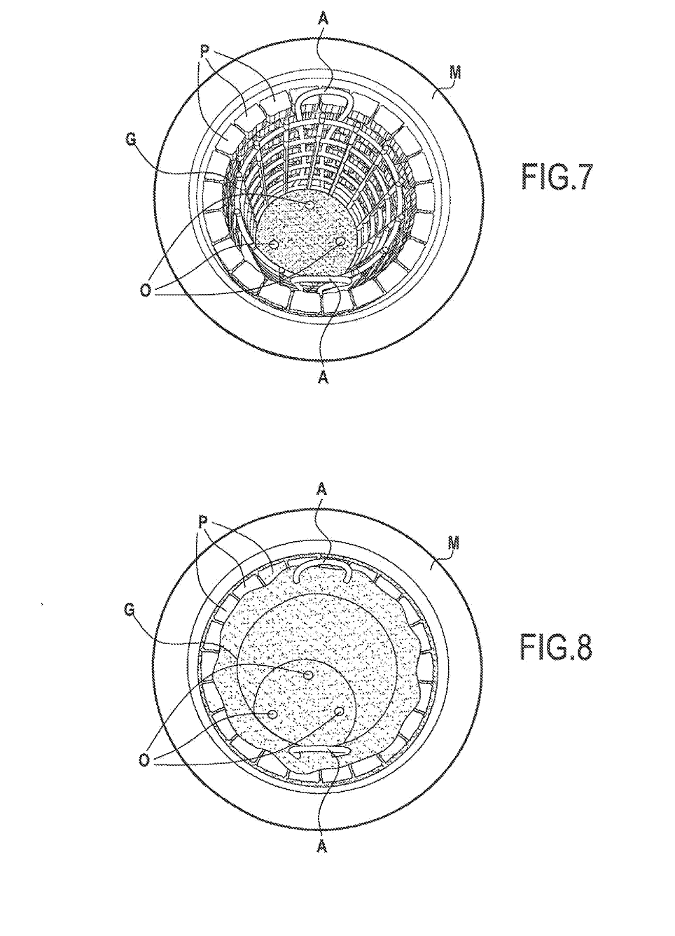

FIG. 7 shows an intermediate time of the step to distribute a pasty binding component B after this component has been applied over the bottom of the mould and after parts T to clear a hole have been sunk into the bottom of the mould M. The hole-forming parts may be pieces of pipe T planted vertically in the bottom of the mould in the thickness of the pasty binding component B and intended to remain permanently in the pot once the binding component B has dried. Another embodiment uses at least one cylinder T successively sunk in the pasty binding component B at the three positions. The cylinder is then removed leaving a hole in the pasty binding component B distributed over the bottom of the mould M, The step to apply the pasty binding component B to the inner side of the inner wall is then performed. If the pasty binding component is very fluid, an inner mould is placed in position to act as inner formwork to hold the binding component in place when it is being applied along the inner walls built with stones. If the pasty binding component is of reduced fluidity it can be rendered over the inner wall built inside the mould.

FIG. 8 shows the inside of the pot obtained after applying the pasty binding component B over the wall of stones P formed by bearing against the inner walls of the mould M. In the bottom of the mould M three holes O can be seen which correspond to the three pipe pieces T planted in the bottom of the pot.

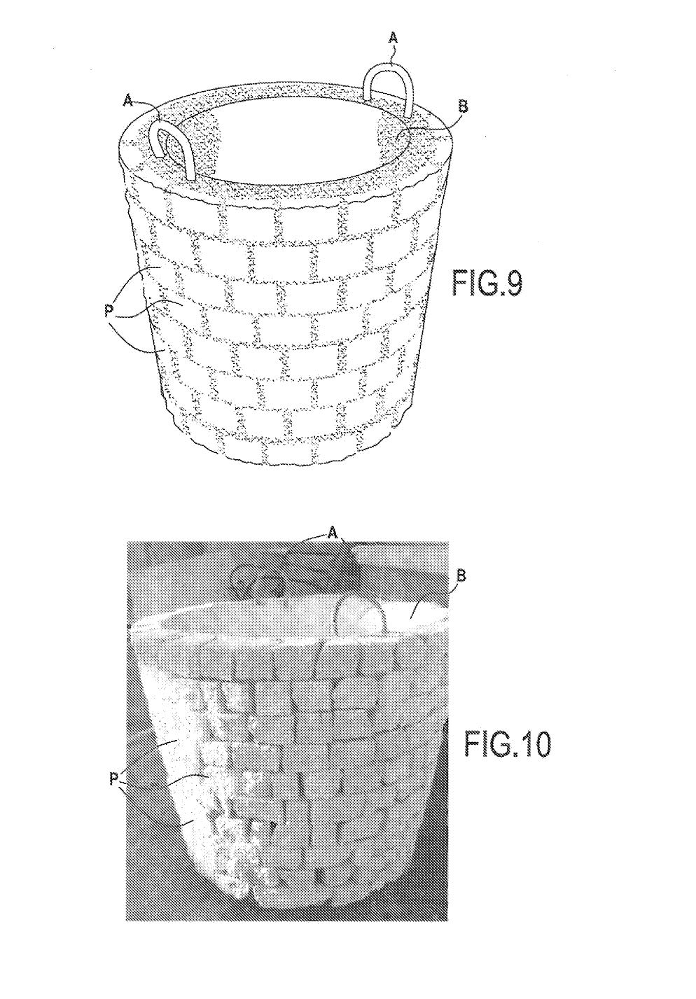

FIG. 9 shows the ornamental horticultural pot such as obtained with the invention, illustrating the stones P on the outer wall, the pasty binding component B inside the pot and the two hoops A used to lift and move the ornamental horticultural pot obtained with the invention. Advantageously the horticultural pot obtained is coated with a layer of protective waterproofing material, This makes it possible to maintain the natural state of the stones and in particular prevents them from blackening over time.

It is noted that FIG. 9 is schematic and shows a pot in which the stones are regular and uniform on the outer side. In reality the stones will not be very straight and uniform as shown in the photo proposed in FIG. 10, Therefore the outer finish is all the more pleasing as the stones used will be reminiscent of the appearance of an actual stone wall.

Finally it is noted that various embodiments can be obtained following the principles of the invention. In particular feet, typically up to 5 feet, can be installed underneath pot. The mould used then comprises protuberances at the bottom corresponding to the feet. The feet are moulded by distributing concrete in the bottom of the mould. Advantageously lightweight concrete e.g. of “perlibeton” type is used as pasty binding component.

The pots can be provided with various types of handles in particular handles smaller than those described in the embodiments presented, or the smaller pots may even have no handles. Retractable rings could also be installed.

Optionally the upper contour of the pot may have finishing stones.

For practical transport, the pots can be divided into several parts including annular parts which can be produced according to the invention. This amounts to producing a pot according to the described method and adding thereupon a pot that is similarly produced but without distributing pasty component over the bottom of the mould.

Pots with open bottoms can also be manufactured. In this case an unblocking part the size of the bottom of the pot is used before distributing the pasty binding component. It is also noted that this unblocking part may also be omitted when it is possible, having regard to the quality of the pasty component, to distribute this paste over the inner wall without spreading into the bottom of the mould. It is noted that the principle of the invention will nevertheless be followed in this case.

Finally it is noted that optionally lighting and/or sprinkler devices can be integrated in the structure of the pot.

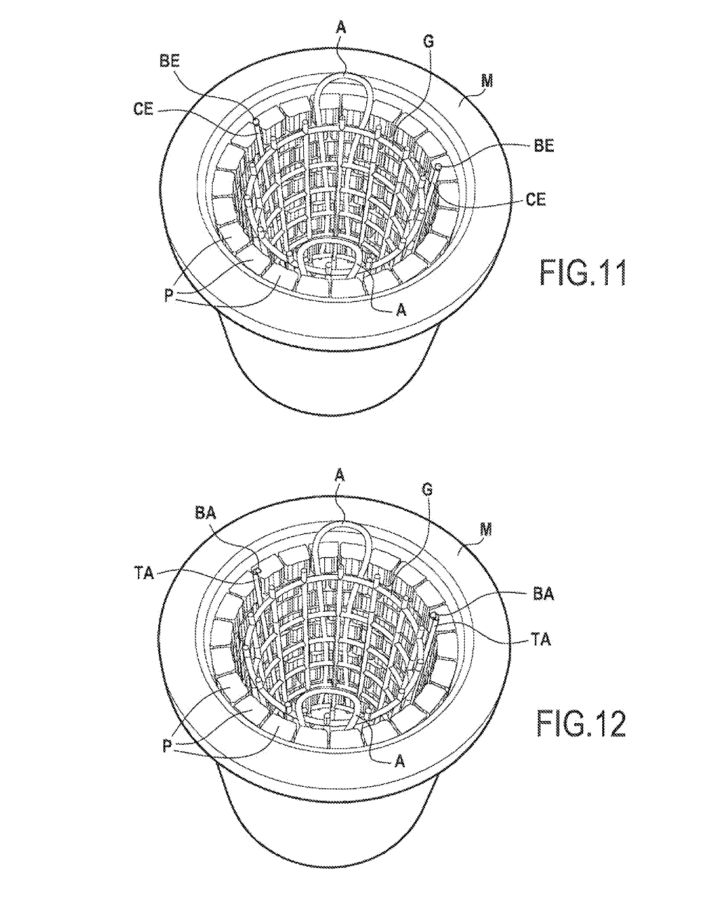

Therefore before the step to distribute the binding component as illustrated in FIG. 11, electric cables CE can advantageously be placed against the inner wall formed by the stacked stones. These cables lead out of the top and bottom of the mould so that they remain accessible after distribution of the pasty binding component over the inner wall. The electric cable CE at its top part ends in a connecting device BE typically for connection to a lamp.

FIG. 12 shows a similar embodiment with hoses TA also placed in position before the pasty component distributing step. These hoses advantageously comprise sprinkler nozzles BA at their top end.

1. A method for producing an ornamental horticultural pot comprising the steps of:
positioning and stacking stones (P) in a wall against the inner walls of a mould (M) of predefined shape corresponding to a desired external shape of the horticultural pot;
distributing a pasty binding component (B) over the bottom of the mould (M) and against the inner all formed by the stack of stones (2) over a thickness observing the thickness-to-height ratio of the pot of between 1/10 and ⅕;
before or immediately after the preceding step, perforating the pasty binding component (B) so as to posit on at least one part to unblock a hole (O) at the bottom of the mould (M), this hole (O) being used for water drainage, this part having a height greater than the planned thickness of the bottom of the pot;
allowing the pasty binding component (B) to dry for a length of time so that it solidifies;
removing the horticultural pot obtained from the mould (M).

2. The method according to claim 1, characterized in that the pasty binding component (B) is distributed over a thickness paying heed to a thickness-to-height ratio of the pot of between ⅛ and 1/7.

3. The method according to claim 1, characterized in that the pasty binding component (B) is chosen from among mortars, adhesive mortars, concretes, cements, coatings, and fibrous adhesives.

4. The method according to claim 1, characterized in that it comprises an intermediate step to place one or more metal structures (G,F) against the inner wall thus formed and/or at the bottom of the mould (M) before applying the binding component (B).

5. The method according to claim 4, characterized in that the metal structure (G,F) is chosen from among wire mesh, crossed iron bars, and intermeshed metal cables.

6. The method according to claim 1, characterized in that a section of pipe can be permanently left in the pot and used as part to unblock a hole (O).

7. The method according to claim 1, characterized in that a solid or hollow cylindrical part which is later removed to clear the hole at the bottom of the pot is used as the part for the unblocking of a hole (O).

8. The method according to claim 1, characterized in that it further comprises a jointing step with waterproofing joints.

9. The method according to claim 1, characterized in that it comprises a step to position at least one hoop-forming structure (A) or allowing the installation of diametrically opposite hoops after the stone (P) positioning step and before the step to distribute the pasty binding component (B).

10. The method according to claim 9, characterized in that the step to position a hoop-forming structure (A) or allowing the installation of hoops is such that this structure (A) is placed between a metal structure (O) and the wall obtained by stacking stones (P) against the inner wall of the mould (M).

11. The method according to claim 9, characterized in that the hoop-forming structure (A) hoops is a metal cable.

12. The method according to claim characterized in that, at least before the step to distribute the pasty binding component (B), it comprises a step to arrange at least one electric cable (CE) from bottom upwards in the mould and leading to outside the top and bottom of the pot after distribution of the binding component.

13. The method according to claim 1 characterized in that, at least before the step to distribute the pasty binding component (B), it comprises a step to arrange at least one pipe (TA) from bottom upwards in the mould and leading to outside the top and bottom of the mould after distribution of the binding element (B).

14. The ornamental horticultural pot obtained with a method according to claim 1.

15. The ornamental horticultural pot according to claim 14, characterized in that the stones (P) are chosen from among marble blocks/slabs, earthenware blocks/slabs, pebbles, natural stones, synthetic stones, breeze blocks, faience, and tiles.

16. The ornamental horticultural pot according to claim 14 characterized in that it is formed of at least two parts, a first so-called lower part obtained using a method according to claim 1 and comprising a bottom, and at least one second annular part having no bottom obtained using a method according to claim 1 and an unblocking part to clear the bottom of this second annular part.
